(19) United States
(12) Patent Application Publication
(10) Pub. No.: US 2023/0306002 A1
(43) Pub. Date: Sep. 28, 2023

(54) HELP DOCUMENTATION ENABLER

(71) Applicant: SAP SE, Walldorf (DE)

(72) Inventors: Garima SRIVASTAVA, Bangalore (IN); Sushama SHADAKSHARY, Bangalore (IN); Akhil HARIKRISHNAN, Bangalore (IN)

(21) Appl. No.: 17/702,924

(22) Filed: Mar. 24, 2022

(51) Int. Cl. G06F 16/21; G06F 16/242; G06F 16/25; G06F 8/73

(52) U.S. Cl. CPC G06F 16/213; G06F 16/2448; G06F 16/252; G06F 8/73

(57) ABSTRACT

According to some embodiments, systems and methods are provided, comprising receiving, at a Help Documentation Enabler (HDE) module, a request for loading an application; identifying one or more displayable fields of the application in response to the received request; determining the one or more identified displayable fields is associated with an annotation; determining the annotation is a documentation annotation by identifying a documentation annotation indicator in a documentation annotation definition is set to TRUE; retrieving a documentation for the field associated with the annotation via a documentation mapper API of the Help Documentation Enabler (HDE) module; converting the documentation annotation definition for the retrieved documentation from a first format to a second format, wherein the second format is associated with the requested application; and rendering the documentation on a user interface of the requested application. Numerous other aspects are provided.

### BACKGROUND

Enterprises often use software, such as Enterprise Resource Planning (ERP) software, to manage day-to-day business activities, including but not limited to, accounting, procurement, project management, risk management and compliance, and supply chain operations. Often the software includes Business Objects, which are representations of parts of the enterprise. A Business Object may represent, for example, a person, place, event, business process, or concept and may exist as, for example, an invoice, a product, a transaction or even details of a person. Business Objects may enable designers to design software in manageable pieces by breaking the enterprise down into a modular form and separating each function into a software object so that as development progresses, increasing complexity can be added to the software without huge changes to the other objects. Every Business Object may have its own associated documentation that describes the corresponding functional behavior of that Business Object. When executing the application, this documentation may be provided to a user as a further explanation of the Business Object.

As enterprises evolve, new software applications may be created that may reuse, consume or enhance features/functionality of these Business Objects. Although the Business Objects may be enhanced, the functional meaning and usage of this Business Object may remain the same. As a non-exhaustive example, if a Purchase Order is the Business Object, the meaning of the Purchase Order remains the same, whether the Purchase Order is shown in an older ERP software application or in a new breed of cloud applications. Additionally, the meaning of “Purchase Order” remains the same through different generations of an ERP software application, between different Line of businesses and domains, etc. However, for the new applications, the documentation must be newly created. As such, to maintain the documentation, developers conventionally manually copy the information into each application. This process may be costly in terms of time and error generation.

Systems and methods are desired in new applications which support the use of documentation of a business object created for previous applications (“legacy documentation”).

### BRIEF DESCRIPTION OF THE DRAWINGS

FIGS. 1A and 1B are non-exhaustive examples of user interfaces according to some embodiments.

FIG. 2 illustrates a system according to some embodiments.

FIG. 3 illustrates a non-exhaustive example of an HDE CDS annotation definition according to some embodiments.

FIG. 4 illustrates a non-exhaustive example of an HDE Documentation mapper API according to some embodiments.

FIG. 5 illustrates a block diagram of the HDE module according to some embodiments.

FIG. 6 is a flow diagram of a process according to some embodiments.

FIG. 7 is a non-exhaustive example of documentation according to some embodiments.

FIG. 8 is a non-exhaustive example of code for rendering the user interface according to some embodiments.

FIG. 9 is a block diagram of a system according to some embodiments.

### DETAILED DESCRIPTION

The following description is provided to enable any person in the art to make and use the described embodiments and sets forth the best mode contemplated for carrying out some embodiments. Various modifications, however, will remain readily apparent to those in the art.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developer's specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

One or more embodiments or elements thereof can be implemented in the form of a computer program product including a non-transitory computer readable storage medium with computer usable program code for performing the method steps indicated herein. Furthermore, one or more embodiments or elements thereof can be implemented in the form of a system (or apparatus) including a memory, and at least one processor that is coupled to the memory and operative to perform exemplary method steps. Yet further, in another aspect, one or more embodiments or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

Documentation is often used by enterprises to provide functional details for the software used by the enterprise. The documentation may be of one or more documentation types including but not limited to data elements (field help), data element supplements, messages, dialog texts, customizing activity documentation, release notes, reports, and general texts.

Data element documentation may be used for field help, where fields are typically entry fields or display fields on the user interface (UI). For each field, a software developer creates a data element. The data element may include at least one of short texts (short description and field labels of different lengths) and a long text. Field help may be context-sensitive information about a field that is not self-explanatory. The data element documentation may be displayed on the user interface directly or in a separate window and may be accessed via selection (e.g., key selection, icon selection, hovering of a cursor) of an element on the UI or automatically displayed.

Customizing activity documentation may describe the purpose of the customizing activity. It may be used to explain any standard settings and, in some cases, how to make individual settings.

Data element supplement documentation may be designed for screen-specific help.

Dialog text documentation may be used for questions displayed in a separate window, requiring the user to make a decision.

General text documentation may be used for texts intended to be re-used.

Message documentation may be message long text and may be used in an instance where users do not know why the message appears or how to deal with the problem before continuing. As a non-exhaustive example, a message long text may tell the user to correct an entry in a field on the screen. In a case the user cannot solve the problem on their own and a system administrator is needed, the message provides information for the system administrator.

Release note documentation may be used for delta documentation about new or changed features.

Report documentation may be used for reports.

The examples described herein will be with respect to data element documentation that may be used for field help. However, the methods and systems described herein may be used with other documentation types.

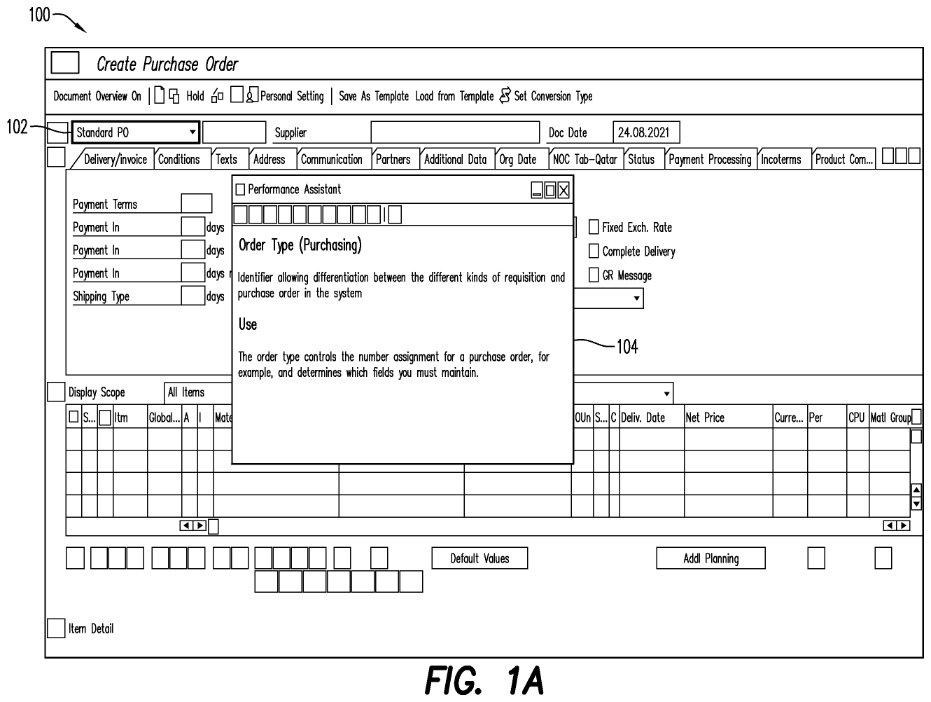

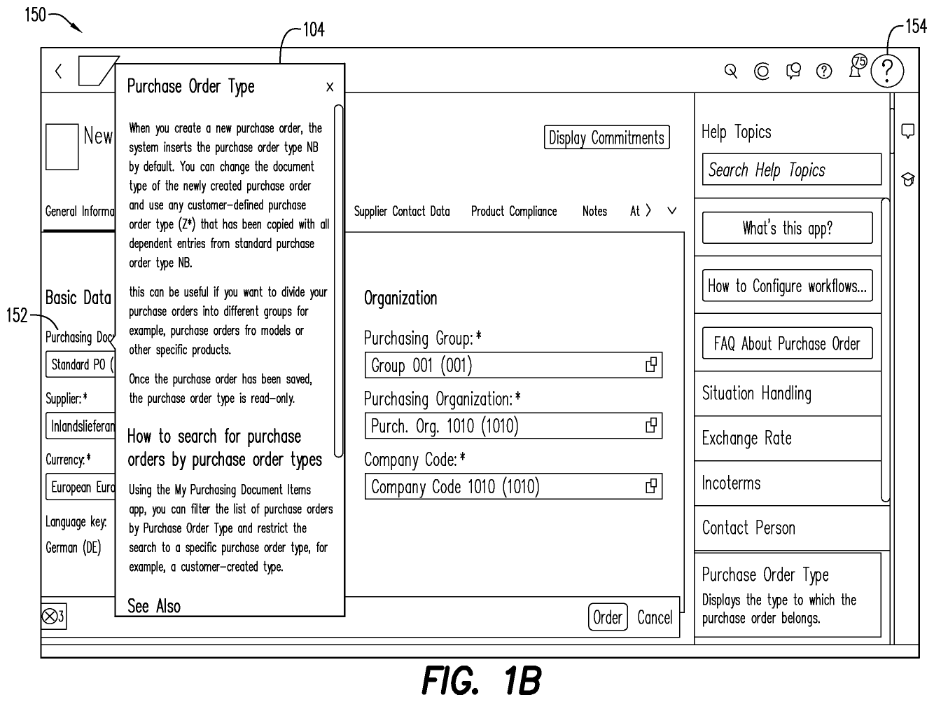

With respect to data element help documentation, this documentation may provide extensive information to an end user from a functional or business perspective. The documentation may be used in a UI for providing additional help regarding screen elements. A user interface 100 (FIG. 1A) associated with a first application may have one or more fields 102 rendered thereon. Each field 102 may be a representation of a corresponding data element/business object. A Business Object, as described above, may be a class that represents an entity. Such a class has certain properties, and may include methods that retrieve those properties. Business logic may be the portion of the application that works with the properties (e.g., uses the business objects to access a database). The documentation may provide meaning for the UI elements so that the user can effectively execute processes. In the non-exhaustive example shown in FIG. 1A, the documentation 104 is displayed on the GUI screen for the drop down “Order Type”. In some instances, this documentation 104 may be accessed via selection of an “F1” key.

FIG. 1B displays a user interface 150 for a second application, and may have one or more fields 152 rendered thereon. The help documentation 104 may be accessed in this application by selection of the “question mark” icon 154 available on the top right corner of the UI. Selection of the question mark icon 154 may cause the documentation 104 to be displayed for the drop down “Purchase Order Type”.

The definition of the underlying Business Object for the data element shown on the UI is the same for the first application in FIG. 1A and the second application in FIG. 1B. Conventionally, the documentation is newly created by developers for each of the first application and the second application. In the event a developer wants to maintain consistency between the applications, the developer conventionally manually copies the information from one application to the other.

It is noted that it may be desirable to maintain the consistency between the applications as a seasoned user who accessed the documentation for a business object in a first application may struggle to understand a different description for the same business object in a second application. Additionally, a new user who reads new documentation for a business object in a second application, may interpret the functional usage differently, thus causing differences in the way business objects are supposed to be used/perceived. Further, the documentation as used in the first application may have evolved over time in response to user feedback and experience, which may be helpful for a user of a second application. The inventors also note that the need to re-use the documentation may be independent of application deployment types. For example, the documentation of a Business Object from an on-premise legacy application may be reused for documenting the same Business Object on a public cloud application.

As used herein, the documentation that is to be re-used may be referred to as “legacy documentation.”

One or more embodiments provide a Help Documentation Enabler (HDE) module that may read legacy documentation used with a first application for a given Business Object and then automatically make this documentation available for use in a second application for the same Business Object. The HDE module may form a channel between documentation used in the first and second applications and may enhance the documentation used in the second application with the legacy documentation. In embodiments, the HDE module may read the legacy documentation, reuse the definition for the documentation from a legacy application in another application, and expose the same to a UI of the other application. Enriching the requesting application with additional information using the processes described herein is less expensive in terms of resource usage when compared to maintaining a whole new repository of information. Since the documentation is attached at the data element level (an object at the deepest level), as described further below, a single change may be automatically reflected across multiple applications, reducing the maintenance costs as well as aiding in consistency of the information that is displayed. Additionally, when compared to conventional methods of generating documentation for the fields in an application, embodiments provide for scaling of the documentation generation at a higher rate as the source of ground truth values is located in a single place (annotation repository). To that end, the UI for any documentation exposing tool may depend on this one repository to display the documentation related to the application. It is also noted that since all the documentation is stored in a same repository, internationalization of texts may be handled automatically by the client where the application is running, eliminating the need for running spoken/written language translation cycles over a separate repository, which further improves the efficiency of the system and reduces maintenance costs.

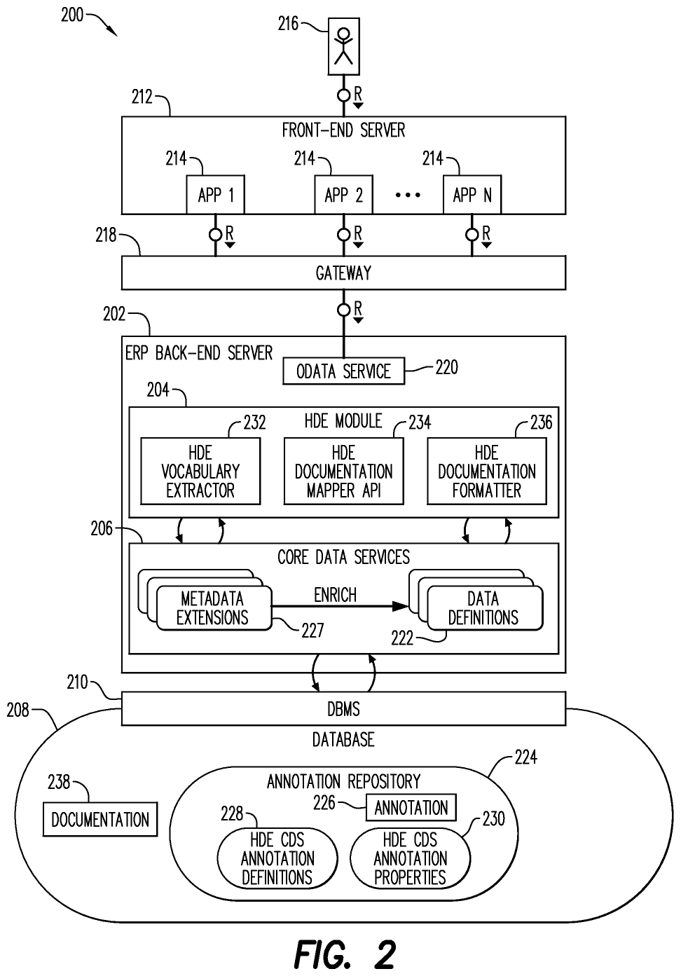

FIG. 2 is a block diagram of system architecture 200 according to some embodiments. Embodiments are not limited to architecture 200.

Architecture 200 includes an ERP back-end platform 202, a HDE module 204, a Core Data Services 206, a database 208, a database management system (DBMS) 210, a front-end server 212, application(s) 214, and clients 216. Applications 214 may comprise server-side executable program code (e.g., compiled code, scripts, etc.) executing within a front-end server 212 to receive queries/requests from clients 216 and provide results (e.g., documentation) to clients 216 based on data of database 208 and the output of the HDE module 204. A client 216 may access the HDE module 204 executing within the ERP back-end platform 202, to retrieve documentation for display on user interfaces 100/150 per the applications 214, as described below.

Front-end server 212 provides any suitable interfaces through which the clients 216 may communicate with the HDE module 204 or applications 214 executing on front-end server 212. The front-end server 212 may, as a non-exhaustive example, be SAP Fiori Launchpad®, or other suitable front-end server. Front-end server 212 may include a Hyper Text Transfer Protocol (HTTP) interface supporting a transient request/response protocol over Transmission Control Protocol/Internet Protocol (TCP/IP), a WebSocket interface supporting non-transient full-duplex communications which implement the WebSocket protocol over a single TCP/IP connection, and/or an Open Data Protocol (OData) interface.

In some embodiments, the system 200 may include a gateway 218 to connect the front-end server 212 to the ERP back-end platform 202. The gateway 218 may use OData protocol for the connection. A non-exhaustive example of the gateway is SAP Gateway®. While the gateway 218 is shown herein, other embodiments may not use the gateway 218.

The ERP back-end platform 202 may include a plurality of integrated resource planning modules/applications (not shown) that communicate with each other sharing a common database 208. A non-exhaustive example of an ERP back-end platform is SAP S/4 HANA®. The ERP back-end platform 202 may include an OData interface service 220 for communication with the front-end server 212, for example. The OData interface service 220 is a non-exhaustive example of an HTTP-based Application Programming Interface (API), which is a software intermediary that, via a set of functions and procedures, allows two applications to communicate with each other. The API acts as a messenger, which takes a request from a requesting application to access the features or data of a target operating system, application or other service, delivers the request to the target, and returns a response to the requesting application. OData is a data access protocol used to query and update data and to trigger business logic. OData is designed to provide standard Create Read Update and Delete (CRUD) access via HTTP(S) and provides for synchronous request with a response. In some embodiments, the OData Service 220 may use a Service Adaptation Description Language (SADL) framework to translate the queries of the data definitions in the OData Service to be read by the database.

The ERP back-end platform 202 may host Core Data Services (CDS) 206. CDS 206 is an infrastructure that can be used by database developers to create the underlying (persistent) data model (which represent relationships in the database) which application services expose to UI clients as a CDS view. A CDS view is a virtual data model which allows direct access to underlying tables of the database. With CDS, the data models are defined and consumed on the database rather than the front-end server. CDS 206 is an enhancement of SQL which provides a Data Definition Language (DDL) for defining semantically rich database tables/views (CDS entities) and user-defined types in the database. CDS 206, including data definitions 222, may be created as a wrapper around a business object to define the process to retrieve the requested data. A non-exhaustive example of a data definition 222 is: Select ABC from database table XYZ.

An example of an enhancement is an annotation 226, which is used to enrich the data models with additional (domain specific) metadata. Annotations 226 are code snippets that may be used to define additional characteristics or functions of a metadata element to a CDS view. An annotation 226 may enrich a data definition 222 and may be specified for specific scopes of an object, namely specific places in a piece of source code. The annotation 226 may be a header annotation (placed at the header region of the file and affect the entire CDS view) or a body annotation (placed before a line of code, and only affect that line). Annotations 226 may be stored in an annotation repository 224 in the database 208.

The CDS 206 may also include metadata extensions 227. A metadata extension 227 is a file that enriches/enhances the data definitions 222 with respect to the data used in the UI. The metadata extension 227 extends a CDS entity with CDS annotations that enrich data definitions 222 with metadata information such as text arrangement on UI, selection type, value help associations, etc. A metadata extension 227 enables a developer to write UI annotations for a CDS entity to enrich the CDS entity data definition 222, while being separate from the data definition 222. CDS data definitions 222 are available as DDL source code. Similarly, the metadata extension 227 may be available in the CDS 206 as DDLX (Data Definition Language Extension) source code. The metadata extension available in DDLX type objects may be validated against a repository of annotations, as described further below.

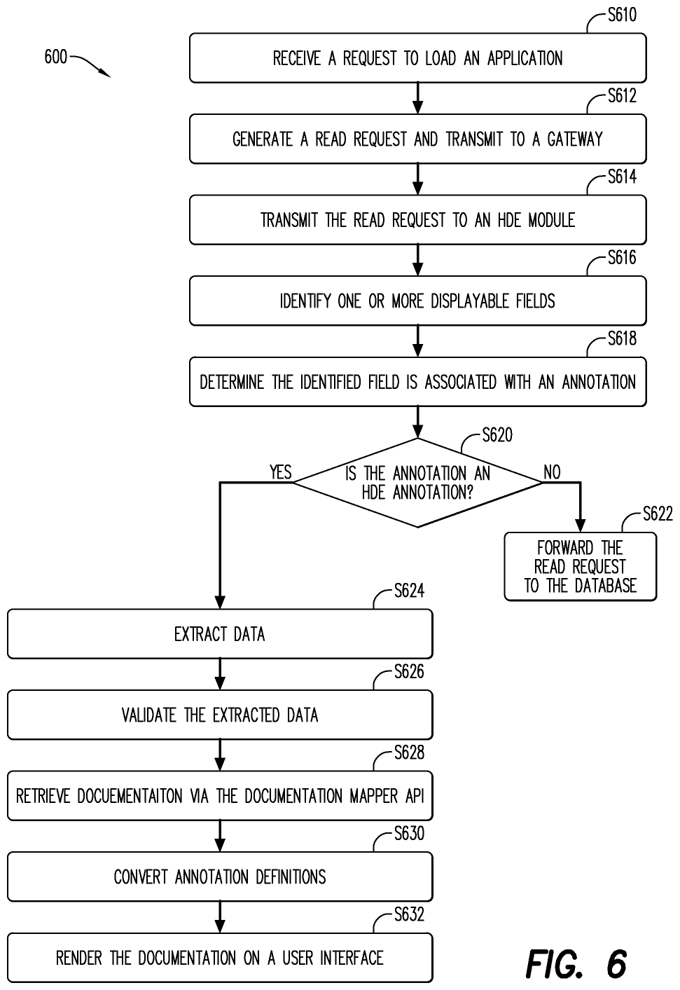

In embodiments, the HDE module 204 may use annotations to derive information from documentation objects in a first application (for e.g., F1 help documentation, data elements documentation, Business Add In (BAdI) documentation (where a BADI is a source code plug-in provided by SAP to enhance existing code, using an object-oriented method), etc.) for use in a second application, as described in the process 600 further below with respect to FIG. 6. The annotation used by the HDE module 204 in the process 600 may be a new annotation type including a specific key (e.g., HDEFieldDocumentation) to signify this annotation is associated with a legacy documentation to be displayed by a requesting application.

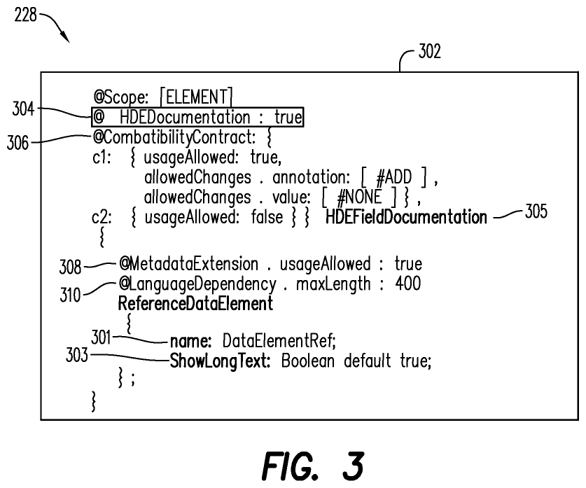

The annotation repository 224 may also include two design-time repository artifacts—an HDE CDS annotation definition 228 (“generated documentation annotation definition”) and an HDE CDS annotation property 230 (“generated documentation annotation property”). The HDE CDS annotation definition 228 is a CDS annotation definition (a DDLA— Data Definition Language Annotation—piece object) that may be responsible for providing the definition of the new annotation type. This HDE CDS annotation definition 228 may define the scope of the new annotation type and the usage. A non-exhaustive example of an HDE CDS annotation definition 228 is shown in FIG. 3. In this non-exhaustive example, the annotation definition is for a Business Object representing a field with a data element. Each field displayed on a UI may be associated with a data element in the database, and each data element has a documentation of its own. The HDE CDS annotation definition 228 indicates where to retrieve the documentation for this data element. As a further example, field “ABC” has DataElement (_DE), so the property “name” would have a value of “_DE”. In FIG. 3, the name 301 is the attribute of the property “ReferenceDataElement” for the HDE CDS annotation definition. Here, in FIG. 3, the annotation is HDEFieldDocumentation, the property of this annotation is ReferenceDataElement and the attributes of the property are Name, ShowLongText.

Each documentation may include a long text feature, a short text feature, a show summary feature (and other features). The code may have a long text indicator 303, such as “ShowLongText” in FIG. 3. In a case the long text indicator 303 is set to “true”, the HDE module 204 may display the long text of the documentation on the UI. The HDE CDS annotation definition 228 may include other indicators for the other features (e.g., a short text indicator that may be set to true or false, a show summary indicator that may be set to true or false, etc.)

The new annotation type 305 may be defined as “HDEFieldDocumentation.” FIG. 3 is an example of a Data Element Reference being annotated with the new reference type. The HDE CDS annotation definition 228 may include a scope 302. In the non-exhaustive example shown herein, a scope 302 of “#Element” indicates that this particular annotation is only applicable at the element level, meaning it is only applicable at the field level (i.e., the definition is just targeting the field level (HDEFieldDocumentation).)

The HDE CDS annotation definition 228 may include an HDE identifier 304 that identifies the annotation as an HDE annotation. The HDE identifier 304 may be called HDEDocumentation, and when set to “true” for the annotation definition, may trigger the HDE module 204, as explained further below with respect to process 600 in FIG. 6, to extract this annotation definition at runtime.

The HDE CDS annotation definition 228 may also include a Compatibility Contract 306, which may indicate the terms for making the annotation available to users. In a case the compatibility contract 306 states for c1: (“usageAllowed: true”), this means that this particular annotation, along with the field level scope, may be released/made available to users for c1, and may be extended further by the users (e.g., allowedChanges.annotation: [#ADD]). In a case the Compatibility Contract 306 states for c2: (“usageAllowed: false”), this means the annotation for c2 would not be available for release to users.

The HDE CDS annotation definition 228 may further include a MetadataExtension.usageAllowed 308. In a case the MetadataExtension.usageAllowed code 308 is “true”, the annotation may only be used with reference to a metadata extension, and not used alone with the data definition.

The HDE CDS annotation definition 228 may further include a LanguageDependency.maxLength 310. This is the number of characters permitted in the documentation. While 400 is shown herein, any suitable number of characters may be used.

The HDE CDS annotation property 230 is responsible for holding all the properties defined in the HDE CDS annotation definition 228 as an enumeration. These properties may be stored in a database table SADL_GW_ANN_EM (or other suitable table) with the related enumerations. These two design-time repository artifacts (HDE CDS annotation definition 228 and the HDE CDS annotation property) may allow an application developer at design time to use the new annotation type in the metadata extension files 227, which in turn may enrich the CDS views with the available metadata information at runtime.

The HDE module 204 may include three design-time artifacts: an HDE Vocabulary Extractor 232, an HDE Documentation Mapper API 234 and an HDE Documentation Formatter 236. The HDE Vocabulary Extractor 232, HDE Documentation Mapper API 234, and HDE Documentation Formatter 236 may interact with the CDS 206 to retrieve the data from the database 208.

The HDE Vocabulary Extractor 232, at runtime, may extract metadata extension files 227 for the data element/field of the requesting application, the HDE CDS annotation definition 228 and the HDE CDS annotation properties 230 for the data/element field from the annotation repository 224. The HDE Vocabulary Extractor 232 may validate the information against each other.

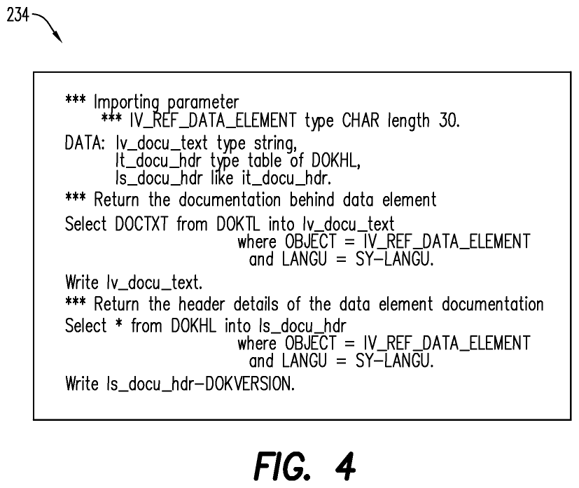

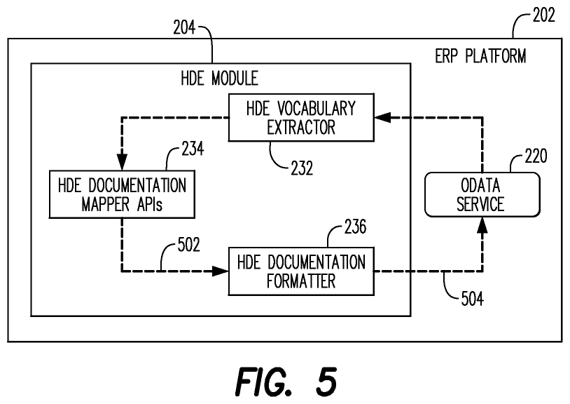

The HDE Documentation Mapper API 234 may retrieve the relevant documentation with respect to the given field/data element extracted by the HDE Vocabulary Extractor 232. The documentation 238 may be available in a database table (“documentation source”) (e.g., DOKTL) which stores the documentation contents for each data element. The documentation header details for the data element may be stored in a different database table (e.g., DOKHL). FIG. 4 provides a non-exhaustive example of the HDE Documentation Mapper API 234. This HDE Documentation Mapper API 234, when executed, may retrieve legacy documentation (DOKTXT) from the database table (DOKTL) for the object/data element, called in this non-exhaustive example, REF_DATA_ELEMENT. The retrieved legacy documentation may be referred to herein as “CDS annotation results” 502 (FIG. 5)

The HDE Documentation Formatter 236, at runtime, may translate the CDS annotation results 502 to OData annotation terms. Then the HDE Documentation Formatter 236 may associate every property in the OData service terms with a metadata information (e.g., type, length, editability, etc.). The translation and association may generate a formatted definition of the documentation 504. The formatted definition of the documentation 504 may then be returned to the OData Service 220 as an added meta-information to be rendered for each field in the UI.

One or more embodiments provide for deployment of the HDE Module 204 as one of: 1. In-built with an ERP platform stack, or 2. Provisioned as a Software as a Service (SaaS) stack on a business technology platform. With the SaaS deployment, users may use the HDE module independent of their source ERP version hosted either on on-premise or on a Cloud.

One or more applications 214 executing on server 212 may communicate with DBMS 210 using database management interfaces such as, but not limited to, Open Database Connectivity (ODBC) and Java Database Connectivity (JDBC) interfaces. These types of applications 214 may use Structured Query Language (SQL) to manage and query data stored in database 208.

DBMS 210 serves requests to retrieve and/or modify data of database 208, and also performs administrative and management functions. Such functions may include snapshot and backup management, indexing, optimization, garbage collection, and/or any other database functions that are or become known. DBMS 210 may also provide application logic, such as database procedures and/or calculations, according to some embodiments. This application logic may comprise scripts, functional libraries and/or compiled program code. DBMS 210 may comprise any query-responsive database system that is or becomes known, including but not limited to a structured-query language (i.e., SQL) relational database management system.

ERP back-end platform 202 may provide application services (e.g., via functional libraries) which applications 214 may use to manage and query the data of database 208. The application services can be used to expose the database data model, with its tables, hierarchies, views and database procedures, to clients. In addition to exposing the data model, ERP back-end platform 202 may host system services such as a search service.

Database 208 may store data used by at least one of: applications 214 and the HDE module 204. For example, database 208 may include an annotation repository 224 storing annotations 226, HDE CDS annotation definitions 228, HDE CDS annotation properties 230, and documentation 238 accessed by the HDE module 204 during execution thereof.

Database 208 may comprise any query-responsive data source or sources that are or become known, including but not limited to a structured-query language (SQL) relational database management system. Database 208 may comprise a relational database, a multi-dimensional database, an extensible Markup Language (XML) document, or any other data storage system storing structured and/or unstructured data. The data of database 208 may be distributed among several relational databases, dimensional databases, and/or other data sources. Embodiments are not limited to any number or types of data sources.

Client 216 may comprise one or more individuals or devices executing program code of a software application for presenting and/or generating user interfaces to allow interaction with front-end server 212. Presentation of a user interface as described herein may comprise any degree or type of rendering, depending on the type of user interface code generated by front-end server 212.

For example, a client 216 may execute a Web Browser to request and receive a Web page (e.g., in HTML format) from a website application 214 of front-end server 212 to provide the UI 100/150 via HTTP, HTTPS, and/or WebSocket, and may render and present the Web page according to known protocols. The client 216 may also or alternatively present user interfaces by executing a standalone executable file (e.g., an .exe file) or code (e.g., a JAVA applet) within a virtual machine.

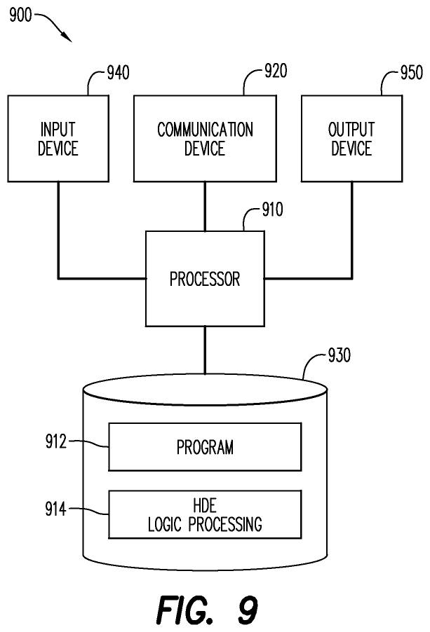

FIG. 6 describes a process 600 for the use of a first application legacy documentation to describe an object in a second application. Process 600 may be executed by front-end server 212 and ERP back-end platform 202 (FIG. 2) according to some embodiments. In one or more embodiments, the front-end server 212 and ERP back-end platform 202 (FIG. 2) may be conditioned to perform the process 600, such that a processor 910 (FIG. 9) of the system 200 is a special purpose element configured to perform operations not performable by a general-purpose computer or device.

All processes mentioned herein may be executed by various hardware elements and/or embodied in processor-executable program code read from one or more of non-transitory computer-readable media, such as a hard drive, a floppy disk, a CD-ROM, a DVD-ROM, a Flash drive, Flash memory, a magnetic tape, and solid state Random Access Memory (RAM) or Read Only Memory (ROM) storage units, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

Prior to the start of the process 600, an application developer writes an HDE CDS annotation definition 228 (“documentation annotation definition”) and corresponding HDE CDS annotation property 230 (“documentation annotation properties”) and stores it in the Database (Annotation repository 224). The inventors note that the application developer may only need to write the HDE CDS annotation definition 228 and corresponding HDE CDS annotation property 230 only once. The developer then uses this annotation for each field 102 shown on a UI 100. To facilitate the description, the UI 100 shown in FIG. 1A will be considered a first application which originated the documentation that will be used as legacy documentation by the UI 150 (FIG. 1B) in the second application.

Initially, at S610, a request to execute/load an application 214 is received at the front-end server 212. A read request, in response to the received load request, may be generated and transmitted to the gateway 218 in S612. The gateway 218 transmits the read request to the HDE module 204 via the OData Service 220 in S614.

Then, in S616, the HDE Vocabulary Extractor 232 identifies one or more displayable fields (e.g., 152 in FIG. 1B) in the User Interface (e.g., 150 in FIG. 1B). In one or more embodiments, the HDE Vocabulary Extractor 232 may identify the displayable fields via an identifier (not shown) in the application code. The identifier may identify the data element that is represented by the displayable field. As described above, the data element may be linked to documentation 238. It is noted that while the following process will be described with respect to one identified field, the process would be repeated for each identified field.

Next, the HDE Vocabulary Extractor 232, in S618, determines the identified field/data element is associated with an annotation in the requested application. The HDE Vocabulary Extractor 232 may determine an annotation is present for the data element represented by the field by an annotation code snippet in the data definition 222. In some embodiments, the HDE Vocabulary Extractor 232 may send a request to the CDS 206 to determine whether the annotation code snippet is present in the data definition 222.

Then, in S620, the HDE Vocabulary Extractor 232 determines whether the annotation is a HDE CDS annotation definition 228. The determination is made via identification of an HDE CDS annotation identifier 304. In some embodiments, the presence of a “HDEFieldDocumentation” code snippet may be the identifier itself to identify the annotation as an HDE CDS annotation. In some embodiments, the HDE Documentation identifier 304 may be a documentation annotation indicator that in a case of being set to “true” may identify the annotation as an HDE CDS annotation. Other suitable identifiers may be used. As a non-exhaustive example, the code snippet for an annotation (not an HDE CDS annotation) may be @ValueHelp. This code snippet is included in the data definition. It is noted that the annotation data element has the same title in both the annotation repository 224 and in the data definition 222 that is ultimately rendered on the User Interface.

In a case the HDE Vocabulary Extractor 232 determines the annotation is not an HDE CDS annotation definition, via the absence of an HDE CDS annotation identifier 304 or the HDE CDS annotation identifier 304 being set to “false” or other suitable indicator, the process 600 may continue to S622, and the HDE module 204 forwards the read request to the database to retrieve the requested information from the database 208 and return it for rendering and display on the UI.

In a case the HDE Vocabulary Extractor 232 determines the annotation is an HDE CDS annotation definition 228, the HDE Vocabulary Extractor 232 may extract in S624, the HDE CDS annotation definition 228, and the HDE CDS properties 230. Then in S626 the HDE Vocabulary Extractor 232 may validate the extracted properties from the metadata extension file 227 against the annotation repository HDE CDS annotation definition 228 for that data element to determine whether the properties in the HDE CDS annotation properties 230 match those of the extracted properties from metadata extension file 227. The validation may also confirm there is a link between the data definition 222 for the field/data element of the requesting application and legacy documentation in a data repository for a corresponding field/data element.

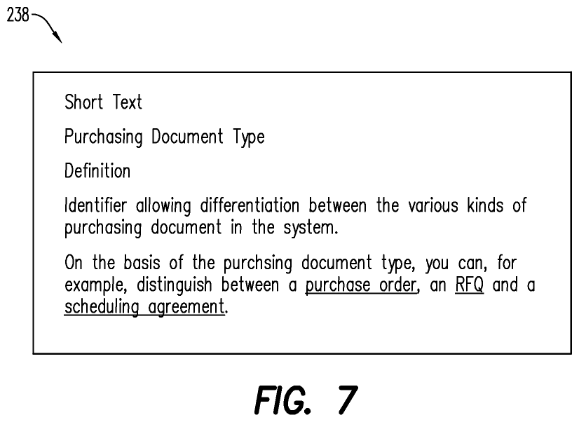

Consider as a non-exhaustive example the field “Purchase Order Type” in the requesting application. On the UI, the field is labeled “Purchase Order Type,” and in the database it is linked to the data element “ESART”. This linking information may be referred to as “metadata information”, and the UI for this linked metadata information may be enriched using metadata extensions. When the renderer for the UI reads the metadata information, it includes the “Purchase Order” label for the ESART data retrieved from the database. The documentation 238 linked to the data element ESART is shown in FIG. 7. With respect to the HDE CDS annotation definition 228 shown in FIG. 3, the “name” would be “ESART,” indicating which documentation to retrieve. As will be further described below, this legacy documentation with respect to ESART is rendered via the requesting application. To render this documentation and enrich the documentation provided for the field “Purchase Order Type” via the requesting application, the developer, when writing the code for the requesting application, may include the following code:

```
  @HDEFieldDocumentation{
    ReferenceDataElement: {
name: ‘ESART’
}
}
PurchaseOrderType;
```

Then, the HDE Vocabulary Extractor 232 forwards the extracted HDE CDS annotation definition 228 and the HDE CDS annotation properties 230 to the HDE Documentation mapper API 234. The HDE Documentation mapper API 234 retrieves the documentation 238 from the database 208 in S628 per the API, which incorporates elements from the extracted HDE CDS annotation definition 228 and the HDE CDS annotation properties 230. A non-exhaustive example of an HDE Documentation mapper API 234 is shown in FIG. 4. The database 208 may store details for the data element in database tables. As a non-exhaustive example, a DOKTL table may store the documentation contents for the data element and a DOKHL table may store the documentation header details for the data element.

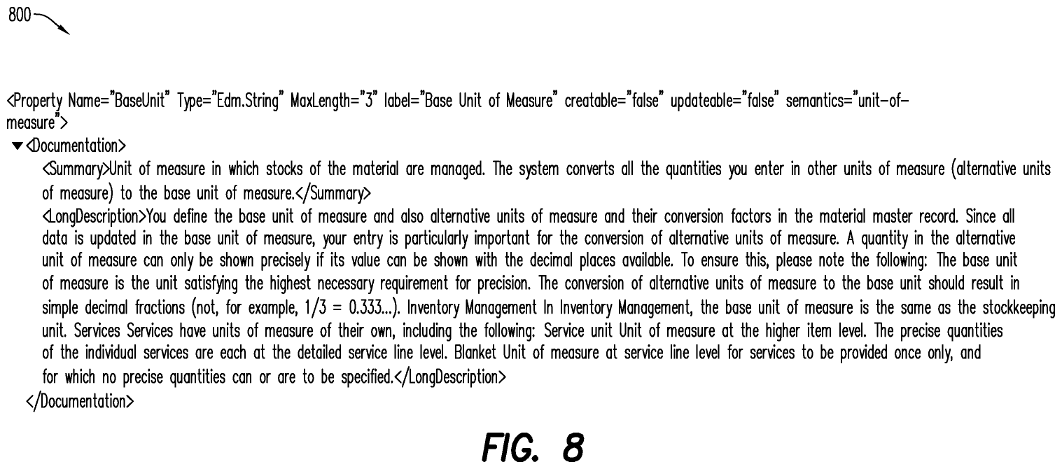

Next, the HDE Documentation mapper API 234 returns the documentation behind the data element, including the header details (“CDS annotation results 502”) to the HDE Documentation Formatter 236. The HDE Documentation Formatter 236 then converts the CDS annotation definition 228 for the data element to a definition using OData annotation terms and formats the definition and documentation in a JSON format or an XML, format used by the OData Service 220 in S630. After the conversion, the HDE Documentation Formatter 236 associates every property in the OData Service 220 with a metadata information including, but not limited to, type, length, eligibility, etc. In embodiments, the HDE Documentation Formatter 236 may use a Service Adaptation Description Language (SADL) framework/model to convert the CDS terms to the OData terms. The SADL model may be a framework that manages the runtime for OData services 220, and offers access between the CDS and OData requests. Following the conversion and association, the legacy documentation is added meta-information to the field. The inventors note that in this way, each field on the requested application may be bound to not only the values from the database but also the meta information. As a non-exhaustive example, FIG. 8 includes the XML code 800 of the documentation for rendering on the UI. The XML code 800 may include the Long Description per the “ShowLongText” indicator marked as “true” in the definition shown in FIG. 3. The XML code 800 may also include a “Summary”, which is an OData terms that is mapped to the CDS term “ShortText”.

In S632, the documentation 238X is rendered on the UI, as shown in FIG. 1B. In some embodiments, the documentation 238 may be rendered on the UI “on demand” when triggered by a user. As a non-exhaustive example, the user may select an indicator (e.g., a question mark 154, or key) which may result in the display of the documentation. In some embodiments, the documentation 238 may be bound to the field, so that the documentation is presented with the field and displayed as an initial rendering of the user interface. The presentation of the documentation may be when the field is rendered on the UI and/or when a user hovers a cursor over a field, for example, the documentation is presented.

FIG. 9 is a block diagram of apparatus 900 according to some embodiments. Apparatus 900 may comprise a general- or special-purpose computing apparatus and may execute program code to perform any of the functions described herein. Apparatus 900 may comprise an implementation of one or more elements of system 200. Apparatus 900 may include other unshown elements according to some embodiments.

Apparatus 900 includes HDE processor 910 operatively coupled to communication device 920, data storage device 930, one or more input devices 940, one or more output devices 950 and memory 960. Communication device 920 may facilitate communication with external devices, such as front-end server 212 and ERP back-end platform 202. Input device(s) 940 may comprise, for example, a keyboard, a keypad, a mouse or other pointing device, a microphone, knob or a switch, an infra-red (IR) port, a docking station, and/or a touch screen. Input device(s) 940 may be used, for example, to manipulate graphical user interfaces and to input information into apparatus 900. Output device(s) 950 may comprise, for example, a display (e.g., a display screen) a speaker, and/or a printer.

Data storage device/memory 930 may comprise any device, including combinations of magnetic storage devices (e.g., magnetic tape, hard disk drives and flash memory), optical storage devices, Read Only Memory (ROM) devices, Random Access Memory (RAM), cloud platforms (e.g., cloud object stores, cloud-based block storage devices,) etc.

The storage device 930 stores a program 912 and/or HDE platform logic 914 for controlling the processor 910. The processor 910 performs instructions of the programs 912, 914, and thereby operates in accordance with any of the embodiments described herein, including but not limited to process 600.

The programs 912, 914 may be stored in a compressed, uncompiled and/or encrypted format. The programs 912, 914 may furthermore include other program elements, such as an operating system, a database management system, and/or device drivers used by the processor 910 to interface with peripheral devices.

The foregoing diagrams represent logical architectures for describing processes according to some embodiments, and actual implementations may include more, or different components arranged in other manners. Other topologies may be used in conjunction with other embodiments. Moreover, each system described herein may be implemented by any number of computing devices in communication with one another via any number of other public and/or private networks. Two or more of such computing devices may be located remote from one another and may communicate with one another via any known manner of network(s) and/or a dedicated connection. Each computing device may comprise any number of hardware and/or software elements suitable to provide the functions described herein as well as any other functions. For example, any computing device used in an implementation of system 200 may include a processor to execute program code such that the computing device operates as described herein.

All systems and processes discussed herein may be embodied in program code stored on one or more computer-readable non-transitory media. Such non-transitory media may include, for example, cloud computing, a fixed disk, a floppy disk, a CD-ROM, a DVD-ROM, a Flash drive, magnetic tape, and solid-state RAM or ROM storage units. Embodiments are therefore not limited to any specific combination of hardware and software.

The embodiments described herein are solely for the purpose of illustration. Those in the art will recognize other embodiments may be practiced with modifications and alterations limited only by the claims.

What is claimed is:

1. A system comprising:
at least one documentation source storing documentation for one or more displayable fields;
an annotation repository storing a plurality of documentation annotation definitions and documentation annotation properties;
a Help Documentation Enabler (HDE) module including a vocabulary extractor, a documentation mapper API, and a documentation formatter,
a memory storing processor-executable program code; and
a processing unit to execute the processor-executable program code to cause the system to:
receive, at the HDE module, a request for loading an application;
identify one or more displayable fields of the application in response to the received request;
determine, by the vocabulary extractor, the one or more identified displayable fields is associated with an annotation;
determine, by the vocabulary extractor, the annotation is a documentation annotation;
retrieve documentation for the field associated with the annotation via the documentation mapper API;
convert, via the documentation formatter, the documentation annotation definition for the retrieved documentation from a first format to a second format, wherein the second format is associated with the requested application; and
render the documentation on a user interface of the requested application.

2. The system of claim 1, further comprising program code to:
extract a metadata extension file for the annotation associated with the field; and
validate the extracted metadata extension file against the documentation annotation definitions for the field.

3. The system of claim 1, wherein each field is a representation of a corresponding data element.

4. The system of claim 3, wherein the data element is linked to the documentation.

5. The system of claim 1, wherein the annotation is a code snippet adapted to provide an enhancement to a metadata element.

6. The system of claim 1 wherein the first format is a core data service (CDS) and the second format is Open Data Protocol (OData).

7. The system of claim 6, wherein the retrieved documentation is rendered on the user interface in a third format as one of XML format or JSON format.

8. The system of claim 1, wherein the retrieved documentation is rendered in response to selection of an element on the user interface.

9. The system of claim 1, wherein the retrieved documentation is bound to the field and displayed as an initial rendering of the user interface.

10. The system of claim 1, wherein determining the annotation is a documentation annotation further comprises program code to:
identify a documentation annotation indicator in the documentation annotation definition is set to TRUE.

11. A computer-implemented method comprising:
receiving, at a Help Documentation Enabler (HDE) module, a request for loading an application;
identifying one or more displayable fields of the application in response to the received request;
determining the one or more identified displayable fields is associated with an annotation;
determining the annotation is a documentation annotation by identifying a documentation annotation indicator in a documentation annotation definition is set to TRUE;
retrieving a documentation for the field associated with the annotation via a documentation mapper API of the Help Documentation Enabler (HDE) module;
converting the documentation annotation definition for the retrieved documentation from a first format to a second format, wherein the second format is associated with the requested application; and
rendering the documentation on a user interface of the requested application.

12. The computer-implemented method of claim 11, further comprising, prior to receiving the request for loading the application at the Help Documentation Enabler (HDE) module:
receiving documentation annotation definitions and documentation annotation properties; and
storing the received documentation annotation definitions and the documentation annotation properties in an annotation repository.

13. The computer-implemented method of claim 11, wherein each field is a representation of a corresponding data element.

14. The computer-implemented method of claim 13, wherein the data element is linked to the documentation.

15. The computer-implemented method of claim 11, wherein the annotation is a code snippet adapted to provide an enhancement to a metadata element.

16. The computer-implemented method of claim 11 wherein the first format is a core data service (CDS) and the second format is one of OData format.

17. The computer-implemented method of claim 16, wherein the retrieved documentation is rendered in a third format as one of XML format or JSON format.

18. A non-transitory, computer readable medium having executable instructions stored therein to perform a method, the method comprising:
receiving, at a Help Documentation Enabler (HDE) module, a request for loading an application;
identifying one or more displayable fields of the application in response to the received request;
determining the one or more identified displayable fields is associated with an annotation;
determining the annotation is a documentation annotation by identifying a documentation annotation indicator in a documentation annotation definition is set to TRUE;
retrieving a documentation for the field associated with the annotation via a documentation mapper API of the Help Documentation Enabler (HDE) module;
converting the documentation annotation definition for the retrieved documentation from a first format to a second format, wherein the second format is associated with the requested application; and
rendering the documentation on a user interface of the requested application.

19. The medium of claim 18, wherein each field is a representation of a corresponding data element, and the data element is linked to the documentation.

20. The medium of claim 18, wherein the annotation is a code snippet adapted to provide an enhancement to a metadata element.
